(19) United States
(12) Patent Application Publication
(10) Pub. No.: US 2006/0063569 A1
(43) Pub. Date: Mar. 23, 2006

(54) Portable device with versatile user interface

(75) Inventors: Paul E. Jacobs, La Jolla, CA (US); Steven Mergenthaler, Carlsbad, CA (US); Gad Shaanan, La Jolla, CA (US); Theodore R. Santos, Boulder, CO (US); Jeffrey Swanson, Erie, CO (US); Andrew G. Lejman, Lafayette, CO (US); David Larson, Superior, CO (US)

Correspondence Address: QUALCOMM, INC, 5775 MOREHOUSE DR., SAN DIEGO, CA, 92121, US

(73) Assignee: QUALCOMM Incorporated

(21) Appl. No.: 10/945,603

(22) Filed: Sep. 20, 2004

(51) Int. Cl. H04Q 7/32

(52) U.S. Cl. 455/575.1; 455/550.1

(57) ABSTRACT

The disclosed embodiments provide devices and methods for providing versatile user interface for an electronic device. In one embodiment, the device includes a display and a plurality of modular layers, each deployable in a different direction. The method includes deploying one of the modular layers, detecting which one of the modular layers is deployed, and orienting information presented on the display based on the deployed modular layer. In one embodiment, the method provides for detecting which one of the module layers is deployed, and providing an operational mode based on the deployed module layer.

### CROSS-REFERENCE TO RELATED APPLICATIONS

This Application is related to the following U.S. patent application, assigned to the present assignee and hereby incorporated by reference:

application Ser. No. 10/718,125, entitled “A Portable Device with Versatile Keyboard,” Attorney Docket No. 040101, filed Nov. 19, 2003.

### FIELD

The present invention relates to portable electronic devices. More specifically, the invention relates to an electronic device with versatile keyboards that expose different key arrangements and display orientations depending on which keyboard is deployed.

### BACKGROUND

Portable electronic devices such as mobile phones, pagers, handheld computers, personal digital assistants (“PDA's”) and hand-held gaming devices are becoming increasingly popular for both business and personal use. One advantage of these devices is their portability due to their small size, light weight, battery-powered or cordless operation and, in some cases, their wireless communications ability. These features allow these portable electronic devices to be utilized whenever and wherever a user desires.

Because of the increasing popularity of these devices, however, it is not uncommon for a single user to carry more than one of these devices at one time. For example, a user may have a mobile phone and a two-way pager strapped to their belt, while carrying a PDA in a pocket and a gaming device in their bag. As such, having separate devices perform each service or function creates a problem for a user who requires more than one or two services/functions offered by these portable devices.

Designers have realized this problem of device proliferation, and have tried to combine a number of services or functionalities into a single device. In this manner, a user may only require a single device having a number of operational modes that correspond to a number of the desired services or functions. One drawback of incorporating many operational modes into a single device, however, is that each service or function typically has an established configuration, including the overall shape and the number and specific types of components. For example, a mobile phone generally includes a phone keypad consisting of 12 keys: 1 key each for the numbers 0-9, and a separate key for the “*” and “#” characters. Further, a mobile phone is generally oriented for use with its length extending in a vertical axis such that its display unit is positioned above the keypad and such that the alphanumeric or graphical output of the display can be read by a user in this orientation. In contrast, a two-way pager typically includes an alphanumeric keyboard, such as a QWERTY keyboard that may include twice as many keys as a phone keypad. Further, a two-way pager typically has a display with a width greater than a length as viewed during use. In attempting to combine services/functionalities, a designer needs surface area onto which these established orientations and sets of components may be mounted. This increased demand for surface area competes with an overall goal of maintaining a device having a compact and portable size.

Thus, a portable electronic device having multiple layers of functional components is desired that provides for multiple functionalities while having a compact and portable size.

### SUMMARY

The disclosed embodiments provide for a versatile user interface for an electronic device. In accordance with one aspect, the disclosed method provides for deploying one of a plurality of input means, detecting which one of the input means is deployed, and orienting information presented on the display based on the deployed input means.

In accordance with another aspect, the disclosed electronic device includes a first module layer movable in a first direction, a second module layer movably coupled relative to the first module layer, and a third module layer movably coupled relative to the second module layer and movable in a second direction.

Additional aspects and advantages of the disclosed embodiments are set forth in part in the description which follows, and in part are obvious from the description, or may be learned by practice of the disclosed embodiments. The aspects and advantages of the disclosed embodiments may also be realized and attained by the means of the instrumentalities and combinations particularly pointed out in the appended claims.

### BRIEF DESCRIPTION OF THE DRAWINGS

The disclosed embodiments will hereinafter be described in conjunction with the appended drawings provided to illustrate and not to limit the disclosed embodiments, wherein like designations denote like elements, and in which:

FIG. 1 is perspective view of one embodiment of an electronic device having a plurality of module layers in a first or neutral position which may correspond to a first operational mode;

FIG. 2 is a perspective view of the electronic device of FIG. 1 with the upper module layer moved in a first direction relative to the remaining module layers, thereby actuating a second operational mode;

FIG. 3 is a perspective view of the electronic device of FIG. 1 with the lower module layer moved in a second direction relative to the remaining module layers, thereby actuating a third operational mode;

FIG. 4 is a perspective view of the electronic device, corresponding to FIG. 2, including one embodiment of the connection mechanism between the upper and middle module layers;

FIG. 5 is a perspective view of the electronic device, corresponding to FIG. 3, including one embodiment of the connection mechanism between the middle and lower module layers; and

FIG. 6 is a perspective view of one embodiment of the connection mechanism of FIGS. 4 and 5.

### DETAILED DESCRIPTION

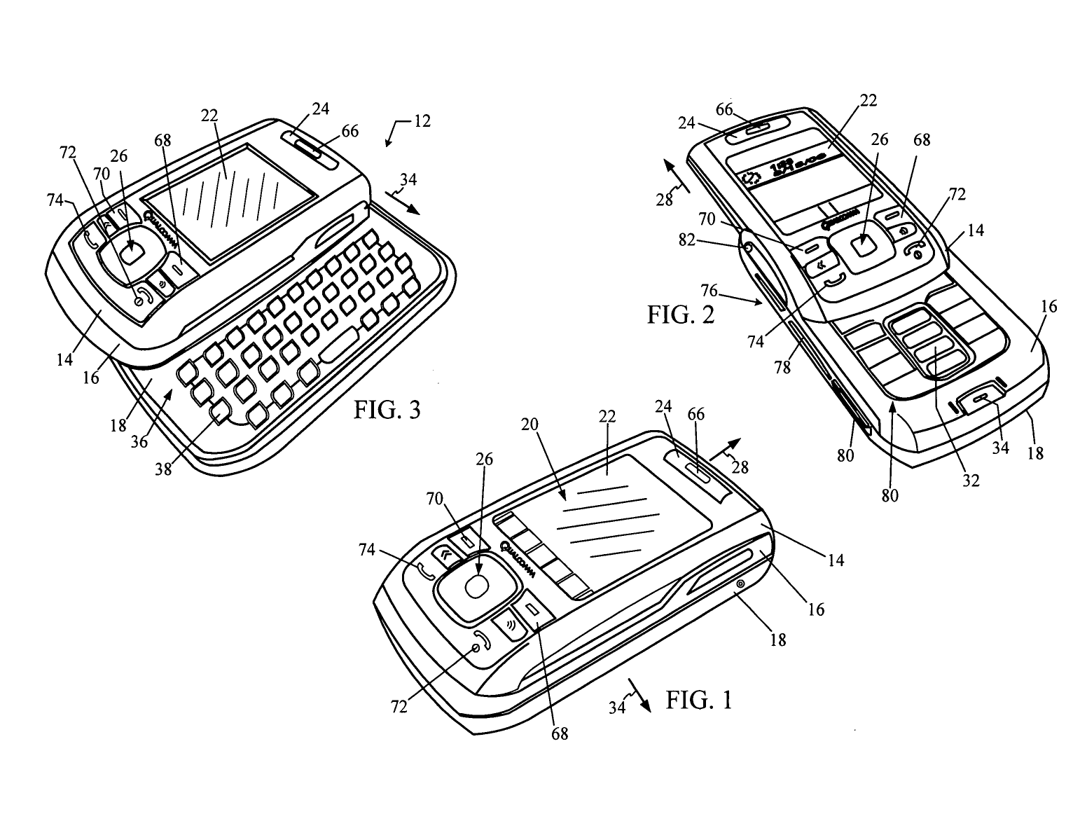

The disclosed embodiments include devices and methods for providing versatile user interface for an electronic device. FIGS. 1-3 illustrate, in one embodiment, an electronic device 12, which has a number of movably coupled module layers 14, 16, 18 that provide electronic device 12 with a number of functional capabilities. In one embodiment, for example referring to FIG. 1, electronic device 12 may have a first operational mode, such as a gaming mode, when module layers 14, 16, 18 are positioned in a first or neutral position where a first set of components 20 such as at least one display unit 22 and directional keypads 24, 26 on the exterior of electronic device 12 may be utilized. Referring to FIG. 2, electronic device 12 may have a second operational mode, such as a phone or audio communications mode, when first module layer 14 is moved in a first direction 28 relative to second and third module layers 16, 18 to expose a first additional set of components 30, such as a phone keypad 31 and microphone 32, on second module layer 16. Further, referring to FIG. 3, electronic device 12 may have a third operational mode, such as a pager, PDA, or text communications mode, when third module layer 18 is moved in a second direction 34 relative to first and second module layers 14, 16 to expose a second additional set of functional components 36, such as a QWERTY keyboard 38, on third module layer 18.

Although shown as including three layers, electronic device 12 may include any plurality of module layers that each may include one or more sets of functional components associated with one or more operational modes. The one or more operational modes enable device 12 to be utilized as one or more of: a mobile, satellite or wireless phone or audio communications device, a gaming device, a personal digital assistant (“PDA”), a pager or text communications device, a global positioning system (“GPS”), a remote control device for controlling another system, an audio player and/or recorder device such as an MP3 player or digital recorder, a static or dynamic video player and/or recorder device, a calculator device, etc. When utilized as a mobile phone, for example, device 12 may include hardware, software and/or firmware for sending and/or receiving communications-related signals using protocols such as a code division multiple access (“CDMA”), wide-band code division multiple access (“WCDMA”), global system for mobile communications (“GSM”), advance mobile phone service (“AMPS”) and time division multiple access (“TDMA”).

The one or more sets of components associated with each layer of device 12, such as module layers 14, 16, 18, may include one or more of plurality of types of functional components. These sets of components include external components, such as input and output type of mechanisms, and also internal components such as circuit boards and circuit elements such as transistors, chips, firmware, memory, software and processing units configured for one or more operational modes of device 12. For example, as mentioned above, first set of components 20 (FIG. 1) may include display 22, which includes any type of textual and/or graphical output unit such as a liquid crystal display, a light-emitting diode display, a touch screen, etc. Directional keypads 24, 26 include toggle keys, navigation keys and other individual or multiple function keys associated with controlling movement of a graphic on display 22 or associated with creating an input signal to device 12.

First set of components 20 may also include other components such as: an audio speaker 66 (FIG. 1), such as a near-field and/or far-field speaker, for outputting audio signals; one or more indicator lights 68, 70 (FIG. 1) for signaling a status of the device 12; operational keys 72, 74 (FIG. 1) such as an on/off or hang-up key and a call accept/send key; volume keys 76 for increasing or decreasing a volume of a speaker such as near-field speaker 66; a push-to-talk button 78 (FIG. 2) for transmitting a voice signal in a walkie-talkie type phone mode; a record key 80 (FIG. 2) for activation a voice recorder functionality; a speaker/microphone input 82 (FIG. 2) for receiving a remote audio speaker and/or microphone connection mechanism; a camera mechanism for taking still or video pictures; a test port for connecting test or monitoring equipment, such as radio frequency (“RF”) signaling equipment, to set-up, repair or test device 12; an infra red (“IR”) transceiver for sending and/or receiving data via IR waves; a battery pack for providing a cordless power source to device 12; a power/data connector for establishing a hard-wired connection to a source of power to operate device 12 and/or recharge the battery pack and to transmit and/or receive data; and an antenna mechanism for transmitting and/or receiving communications signals associated with one or more of the modes of device 12.

Similarly, first and second set of additional components 30, 36 may include other functional components, such as any of the above-mentioned components, associated with a desired operational mode. It should be noted that the components associated with device 12 may be arranged in any combination, and on any layer, in order to achieve a desired configuration for each operational mode of device 12.

In operation, for example, the various operational modes of device 12 are controlled by the relative positioning of each layer of device 12. A method of controlling relative movement between these layers includes movably coupling various module layers to allow relative movement that exposes various functional components associated with each layer. Further, in order to provide a discrete actuation of an individual operational mode, the device further includes a locking mechanism that prevents movement between predetermined layers during actuation of predetermined modes.

In one embodiment, for example, referring back to FIGS. 1-3, the first operational mode of electronic device 12 may be activated by depressing one or a predetermined sequence of keys on the exterior of device 12. For example, the first operational mode may correspond to one or more of a gaming mode, a PDA mode, a camera mode, a GPS mode, a calculator mode, a data transfer mode and/or a phone stand-by mode. First set of components 20 may be utilized in various combinations to achieve the desired functionality of this mode. For instance, when operated as a gaming device in this first mode, device 12 may be held such that its width is its longest dimension, and directional keypads 24, 26 are utilized for controlling gaming functions. Additionally, associated with the actuation of this mode, device 12 may present the text and/or graphics output from display 22 in a predetermined orientation based on the selected operational mode. So, for example, the text/graphics in the gaming mode may be oriented 90 degrees relative to the text/graphics in a phone or PDA mode. Further, first set of components 20 may simultaneously be functioning in more than one mode, such as in a phone stand-by mode, where upon receiving a phone call an output may be generated, such as by one or more of display 22, indicator lights 68, 70 and speaker 66. A user may change device 12 into a phone mode by then sliding upper module layer 14 in first direction 28 or by accepting the call by depressing call accept key 74. In the PDA mode, a user may view data from display 22 and utilize any of the keys or buttons to produce inputs. Further, display 22 may be a touch screen display that allows additional inputs. In the camera mode, a user may operate the camera to take a still picture or a video, which may also allow the user to record any audio signals received by microphone 32 (FIG. 2) and associated with the picture or video. Further, in the data transfer mode, data may be received by or sent from device 12 through one or more of test port, IR transceiver, and power/data connector.

In one embodiment, a user activates a second operational mode, such as the phone mode (FIG. 2), by moving, e.g., sliding, upper module layer 14 in first direction 28 (vertical or upward), and exposing phone keypad 31. During this actuation step, the locking system prevents additional relative movement between the remaining layers that is associated with actuation of additional operational modes. In the phone mode, hardware, software and/or firmware within device 12 recognizes the actuation of this mode and orients the output of display 22 such that it is aligned for use in combination with phone keypad 31. Further, device 12 actuates predetermined internal circuitry associated with the functionality of this mode, such as communications hardware and software for sending and receiving wireless signals. A user may communicate by talking into microphone 32 and by listening to speaker 66. Further, additional phone-related functions may be performed via keystrokes on phone keypad 31 and send key 74, or by using directional keypad 24 or 26. This mode may be turned off, for example, by moving, e.g., sliding, upper module layer 14 back into the neutral position (FIG. 1) or by depressing the off key 72.

A user activates the pager or two-way text communications mode, referring to FIG. 3, by moving, e.g., sliding, lower module layer 18 in second direction 34 (horizontal or sideway) and thereby exposing QWERTY keyboard 38. During this actuation step, the locking system prevents additional relative movement between the remaining layers that is associated with actuation of additional operational modes. In this mode, hardware, software and/or firmware within device 12 recognizes the actuation of this mode and orient the output of display 22 such that it is aligned for use in combination with QWERTY keyboard 38. Further, device 12 actuates predetermined internal circuitry associated with the functionality of this mode, such as communications hardware and software for sending and receiving wireless signals. A user may communicate, for example, by reading received text messages output by display 22 or by entering characters from keyboard 38 and sending to another device via send key 74. This mode may be turned off, for example, by moving, e.g., sliding, lower module layer 18 back into the neutral position or by depressing the off key 72.

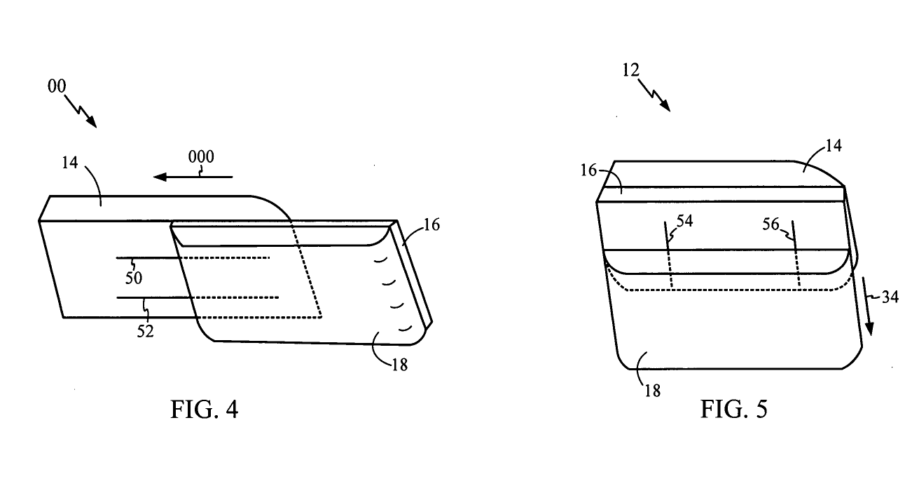

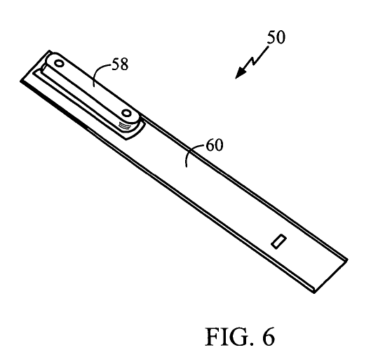

FIGS. 4 and 5 illustrate connection mechanisms 50, 52, 54, 56, which may form a portion of, or provide assistance to, the locking system. One or more connection mechanisms 50, 52, 54, 56 may be utilized to movably couple the module layers 14, 16, 18 such that the various relative movements are achievable. For example, in one embodiment, connection mechanisms 50, 52 movably couple upper and middle module layers 14, 16 for relative movement in first direction 28, while connection mechanisms 54, 56 movably couple middle and lower module layers 16, 18 for relative movement in second direction 34. In this example, connection mechanisms 54, 56 may aid the locking system by preventing relative movement between middle and lower module layers 16, 18 in first direction 28 during relative movement of upper module layer 14 in that direction.

Connection mechanisms 50, 52, 54, 56 may include various types of magnetic connectors and mechanical connectors. In one embodiment, referring to FIG. 6 for example, connection mechanisms 50 or 52 or 54 or 56 include a carrier body 58 movably coupled to a rail member 60 for movement along the length of the rail member. Carrier body 58 may be fixedly attached to one module layer 14, 16, 18, such as by mechanical or chemical fastening, while rail member 60 may be fixedly attached in a similar manner to the adjacent module layer to provide for the desired relative movement between layers. Referring to FIGS. 4 and 5, rail members associated with connection mechanisms 50, 52 have a length extending parallel to first direction 28, while rail members associated with connection mechanisms 54, 56 have a length extending parallel to second direction 34. As such, each carrier body 58 is movable in opposite directions along the length of each rail. As such, in this embodiment, the respective rail members and carrier bodies associated with connection mechanisms 50, 52, 54, 56 respectively provide the relative movement of upper and middle module layers 14, 16 to be substantially perpendicular to the relative movement of middle and lower module layers 16, 18. Further, connection mechanisms 50, 52, 54, 56 may comprise metals, plastics, composites, and ceramics, and they may be formed integrally with each module layer 14, 16, 18 or separately attached via mechanical or chemical methods.

Although in this embodiment, movements of the module layers are represented as bidirectional sliding movements, it should be noted that movements along more than one axis, in more than one plane, and linear and/or rotary sliding and/or flipping movement may also be provided. Further, one or more display units may be provided on one or more of the module layers 14, 16, 18, such that when one or more of the module layers are deployed, a user may observe information on one or more of the display units simultaneously. Such arrangement would allow the user to engage in a phone call while receiving multimedia or playing game on a display unit, and at the same time working on a file on a different display unit, on the same or different module layer.

Thus, the described embodiments provide devices and methods for controlling the actuation of an operational mode of device 12 by allowing certain relative movement between certain module layers while limiting other predetermined relative movements between other module layers. A locking system associated with each module layer is configured to control these various relative movements. While the various disclosed embodiments have been illustrated and described, it will be clear that the subject matter of this document is not limited to these embodiments only. Numerous modifications, changes, variations, substitutions and equivalents will be apparent to those skilled in the art without departing from the spirit and scope of the disclosed embodiments as described in the claims.

What is claimed is:

1. A method for providing a versatile user interface for an electronic device, the device including a display and a plurality of module layers, each deployable in a different direction, the method comprising:
detecting which one of a plurality module layers is deployed; and
orienting information presented on the display based on the deployed module layer.

2. The method of claim 1, wherein said module layers include a keyboard.

3. The method of claim 2, wherein said keyboard is a phone keyboard.

4. The method of claim 2, wherein said keyboard is a PDA keyboard.

5. The method of claim 2, wherein said keyboard is a gaming keyboard.

6. The method of claim 2, wherein said keyboard is a multimedia keyboard.

7. The method of claim 1, wherein said orienting includes orienting information in landscape.

8. The method of claim 1, wherein said orienting includes orienting information in portrait.

9. The method of claim 1, wherein said module layer is deployed in vertical direction.

10. The method of claim 1, wherein said module layer is deployed in horizontal direction.

11. An electronic device, comprising:
a first module layer movable in a first direction;
a second module layer movably coupled relative to the first module layer; and
a third module layer movably coupled relative to the second module layer and movable in a second direction.

12. The device of claim 11, wherein the first module layer comprises a first set of functional components, the second module layer comprises a second set of functional components and the third module layer comprises a third set of functional components, and wherein the device comprises a first operational mode utilizing the first set of functional components, a second operational mode utilizing the second set of functional components and a third operational mode utilizing the third set of functional components, wherein each operational mode is actuated based on a predetermined relative position of the first module layer, the second module layer and the third module layer.

13. The device of claim 12, wherein the first operational mode, the second operational mode and the third operational mode are selected from the group consisting of an audio communication mode, a textual communication mode, a personal digital assistant mode and a gaming mode, a global positioning system (“GPS”) mode, a remote control device mode, an audio player or recorder mode, a static or dynamic video player or recorder device, and a calculator mode.

14. The device of claim 13, wherein the second set of functional components are exposable when the first module layer moves relative to the second module layer in the first direction and thereby defines the second operational mode.

15. The device of claim 13, wherein the third set of functional components are exposable when the third module layer moves relative to the second module layer in the second direction and thereby defines the third operational mode.

16. The device of claim 11, further comprising a first connector coupling the first module layer and the second module layer, wherein the first connector allows at least linear movement substantially parallel to the first direction.

17. The device of claim 16, further comprising a second connector coupling the second module layer and the third module layer, wherein the second connector allows linear movement substantially parallel to the second direction.

18. The device of claim 11, wherein the first direction and the second direction are substantially perpendicular.

19. The device of claim 11, further comprising a communications module having an input and an output respectively for receiving and transmitting a wireless signal.

20. The device of claim 11, further comprising a display for presenting information to a user.

21. The device of claim 20, wherein the information has a first orientation when the first module layer is moved in the first direction relative to the second module layer and a second orientation when the third module layer is moved in the second direction relative to the second module layer.

22. The device of claim 11, wherein the second module layer further comprises a first input mechanism exposable when the first module layer moves in the first direction relative to the second module layer, and wherein the third module layer further comprises a second input mechanism exposable when the third module layer moves in the second direction relative to the second module layer.

23. The device of claim 22, further comprising a display for presenting information to a user, wherein the information has a first orientation when the first input mechanism is exposed and a second orientation when the second input mechanism is exposed.

24. A portable electronic device, comprising:
a first component layer movable in a first direction;
a second component layer having a first set of functional components, the second component layer movably coupled relative to the first component layer such that movement of the first component layer in the first direction exposes the first set of functional components and activates a first operational mode; and
a third component layer having a second set of functional components, the third component layer movably coupled to one of the first component layer and the second component layer, the third component layer movable in a second direction relative to the second component layer to expose a second set of functional components and activate a second operational mode.

25. A method of controlling relative movement between movable layers of an electronic device, comprising:
movably coupling a first module layer to a second module layer having a first functional component such that a relative movement of the first module layer in a first direction exposes the first functional component; and
movably coupling the second module layer to a third module layer having a second functional component such that a relative movement of the third module layer in a second direction exposes the second functional component.
preventing movement of the third module layer in the second direction during movement of the first module layer in the first direction.

26. The method of claim 25, further comprising preventing movement of the first module layer in the first direction during movement of the third module layer in the second direction.

27. A method for providing a versatile user interface for an electronic device, comprising:
exposing a first set of functional components on a second module layer movably coupled to a first module layer, where the first set of functional components is associated with a first operational mode of the electronic device; and
exposing a second set of functional components on a third module layer movably coupled to the second module layer, where the second set of functional components is associated with a second operational mode of the electronic device.

28. The method of claim 27, further comprising displaying information in a predetermined orientation depending on an operational mode of the electronic device.

29. The method of claim 27, wherein said exposing occurs when the corresponding modular layer is moved in a vertical motion.

30. The method of claim 29, wherein said vertical motion includes a sliding motion.

31. The method of claim 30, wherein said sliding motion includes a linear sliding motion.

32. The method of claim 30, wherein said sliding motion includes a rotational sliding motion.

33. The method of claim 30, wherein said vertical motion includes a flipping motion.

34. The method of claim 27, wherein said exposing occurs when the corresponding modular layer is moved in a horizontal motion.

35. The method of claim 34, wherein said horizontal motion includes a sliding motion.

36. The method of claim 35, wherein said sliding motion includes a linear sliding motion.

37. The method of claim 35, wherein said sliding motion includes a rotational sliding motion.

38. The method of claim 34, wherein said horizontal motion includes a flipping motion.

39. An apparatus for providing a versatile user interface for an electronic device, the device including a display and a plurality of module layers, each deployable in a different direction, comprising:
means for detecting which one of a plurality module layers is deployed; and
means for orienting information presented on the display based on the deployed module layer.

40. An apparatus for providing a versatile user interface for an electronic device, comprising:
means for exposing a first set of functional components on a second module layer movably coupled to a first module layer, where the first set of functional components is associated with a first operational mode of the electronic device; and
means for exposing a second set of functional components on a third module layer movably coupled to the second module layer, where the second set of functional components is associated with a second operational mode of the electronic device.

41. A method for providing a versatile user interface for an electronic device, the device including a display and a plurality of module layers, each deployable in a different direction and associated with an operational mode, the method comprising:
detecting which one of a plurality module layers is deployed; and
providing an operational mode based on the deployed module layer.

42. An apparatus for providing a versatile user interface for an electronic device, the device including a display and a plurality of module layers, each deployable in a different direction and associated with an operational mode, comprising:
means for detecting which one of a plurality module layers is deployed; and
means for providing an operational mode based on the deployed module layer.
